(19) United States
(12) Patent Application Publication
(10) Pub. No.: US 2004/0054720 A1
(43) Pub. Date: Mar. 18, 2004

(54) Net-transferor apparatus

(76) Inventor: Ke-Yi Li, Shanghai (CN)

Correspondence Address: Raymond Y. Chan, Suite 128, 108 N. Ynez Ave., Monterey Park, CA, 91754, US

(21) Appl. No.: 10/441,372

(22) Filed: May 19, 2003

(30) Foreign Application Priority Data
May 24, 2002 (CN) 02111819.1

(51) Int. Cl. G06F 15/16

(52) U.S. Cl. 709/203

(57) ABSTRACT

A net-transferor apparatus which is an electronic network system includes a fully functional main machine and one or more terminal devices each of which requests a single function inquiry selectively through the display device to generate directly to the main machine for approval, wherein after the main machine approved the single function inquiry requested from the terminal device, the main machine completes the single function inquiry via the generator and at least one of the display devices. The net-transferor apparatus is able to be used both in ordinary and high level uses such as computers, personal computers, instruments, meters, game players, home teaching machines, and translating machines. The net-transferor apparatus has a vast market demands and if transmitted by cable and satellite, is able to cover the whole globe. If the net-transferor apparatus is manufactured by proper electronic elements or cable, it is able to be anti-hacker.

### BACKGROUND OF THE PRESENT INVENTION

1. Field of Invention

The present invention relates to an electronic network system named net-transferor apparatus, and more particularly to a system of a fully functional and expandable main machine and one or more low cost and simple functional terminal device (receiver/sender).

2. Description of Related Arts

In a conventional network structure, a fully functional server is equipped with a plurality of simple-functional work stations. As the rapid development in science and technology, the program of a variety of instruments, equipments, and computers are more and more powerful and it is often that part of computing power is idle just because of the excessive powerfulness. While the demands on individual machine are increasing significantly and causing a waste of resources. Customers may feel not so cost effective to purchase such current servers that are smaller and smaller in size. Also, due to the limitation of current technology, the networks and computers are often attacked by web hackers that people lose their feel of safety to technology.

### SUMMARY OF THE PRESENT INVENTION

The main object of the invention is to provide a net-transferor apparatus including at least a fully functional and expandable main machine that can minimize the idle time of the apparatus and waste of resources.

Another object of the invention is to provide a net-transferor apparatus which capacity can be expanded unlimitedly while its manufacturing cost remains low and it can prevent the hackers' attack.

Another object of the invention is to provide a net-transferor apparatus including one or more low cost and simple functional terminal device to function as a low cost and simple functioning receiver/sender.

In order to accomplish the above objects, the present invention provides a net-transferor apparatus, which comprises a fully functional and expandable main machine and one or more low cost and simple functional terminal device.

The net-transferor apparatus is operated with a process including the steps of:

(a) requesting a single function inquiry by one of the terminal devices (receiver/sender) selectively through a display device to generate directly (through wired, wireless or combined wire/wireless generation) to the main machine;

(b) approving the single function inquiry requested from the respective terminal devices by the main machine; and

(c) completing, by the main machine, the single function inquiry of the respective terminal device via a generator (which can be a wired, wireless or combined wire/wireless generator) and the display device.

The characteristics of the present invention are that the capacity of the main machine can be expanded unlimitedly for having one or more fully functional main machines. The manufacturing cost of the main machine is relatively low and the functions of the main machine can be extended according to the recent development of technology. When there is a plurality of fully functional main machines, they can be classified due to their professions or associated and assembled due to the need according to the recent development of technology.

Other advantages of the present invention include that the functions of the terminal devices can also be expanded according to the recent development of the technology. It can process professional classification or association and assembly due to the needs. In other words, the terminal devices are receiver/sender in low cost and simple structure, so that the size and the manufacturing cost of the terminal device can be minimized. Moreover, it is easier to maintain and repair when it is out of order. Besides, a system of the net-transferor apparatus of the present invention can widely prevent the hackers' attack domestically and even all over the world.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of a preferred embodiment according to the present invention.

FIG. 2 is another schematic view of the above preferred embodiment according to the present invention.

### DETAILED DESCRIPTION OF THE PREFERRED EMBODIMENT

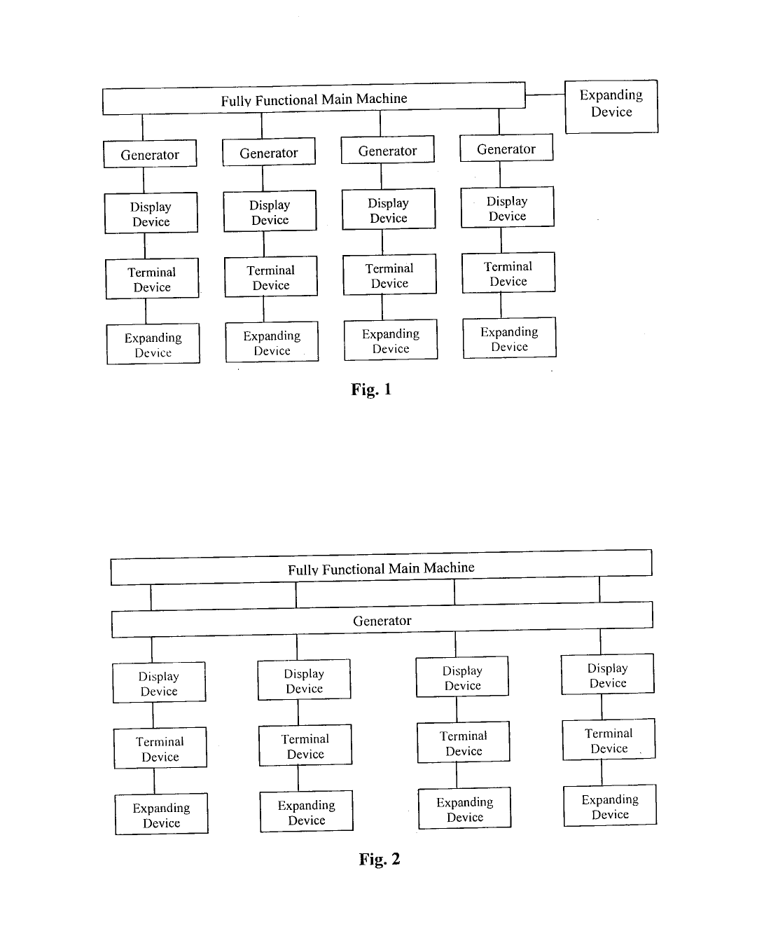

Referring to FIGS. 1 and 2, a net-transferor apparatus according to a preferred embodiment of the present invention is illustrated. The net-transferor apparatus, which is an innovative network system and a new generation of computers and electrical appliances, comprises a fully functional and expandable main machine, one or more low cost and simple functional terminal device, one or more generators, and one or more display devices. The functions of both the main machine and the terminal devices are expandable according to the development of the technology.

The net-transferor apparatus is operated with a process including the steps of:

(a) requesting a single function inquiry by one of the terminal devices (receiver/sender) selectively through a display device to generate directly (through wired, wireless or combined wire/wireless generation) to the main machine;

(b) approving the single function inquiry requested from the respective terminal devices by the main machine, through or not through the display device; and

(c) completing the single function inquiry of the respective terminal device via a generator (which can be a wired, wireless or combined wire/wireless generator) and the display device.

The capacity of the main machine is expandable unlimitedly by having one or more fully functional main machines. The manufacturing cost of the main machine is relatively low and the functions of the main machine can be expanded according to the recent development of technology. When there is a plurality of fully functional main machines, they can be classified due to their professions or associated and assembled due to the need according to the recent development of technology.

Other features of the net-transferor apparatus include that the functions of the terminal devices can also be extended according to the recent development of the technology. It can process professional classification or association and assembly due to the needs. In other words, the terminal devices are receiver/sender in low cost and simple structure, so that the size and the manufacturing cost of the terminal device can be minimized. Moreover, it is easier to maintain and repair when it is out of order. Besides, a system of the net-transferor apparatus of the present invention can widely prevent the hackers' attack domestically and even all over the world.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A net-transferor apparatus which is an electronic network system, comprising:
one or more fully functional main machine;
at least one generator;
one or more display devices; and
one or more terminal devices each of which requests a single function inquiry to said main machine for approval, wherein after said main machine approved said single function inquiry requested from said terminal device, said main machine completes said single function inquiry via said generator and at least one of said display devices.

2. The net-transferor apparatus, as recited in claim 1, wherein functions of said main machine are expandable and able to be professionally classified according to a development of technology and a capacity of said main machine being expanded unlimitedly.

3. The net-transferor apparatus, as recited in claim 1, wherein said main machine and said terminal devices are connected by a connection selected from a group consisting of wired connection, wireless connection and combined wire/wireless connection.

4. The net-transferor apparatus, as recited in claim 1, wherein functions of each of said terminal devices are expandable according to a development of technology and each of said terminal devices is capable of processing professional classification and association due to needs.

5. The net-transferor apparatus, as recited in claim 1, wherein each of said terminal devices comprises an input/output device correspondingly.

6. The net-transferor apparatus, as recited in claim 1, further comprising one or more additional main machines connected with said terminal devices.

7. The net-transferor apparatus, as recited in claim 1, wherein each of said terminal devices is a receiver/sender.

8. The net-transferor apparatus, as recited in claim 1, wherein said single function is requested from said terminal device directly to said main machine for approval via said display device.

9. An operation process of a net-transferor apparatus which comprises a fully functional main machine, at least one generator, one or more display devices, and one or more terminal devices, wherein said process includes the steps of:
(a) requesting a single function inquiry by one of said terminal devices selectively through one of said display devices to generate directly to said main machine;
(b) approving said single function inquiry requested from said respective terminal devices by said main machine; and
(c) completing, by said main machine, the single function inquiry of said respective terminal device via a generator and said display device.

10. The process, as recited in claim 9, wherein functions of said main machine are expandable and able to be professionally classified according to a development of technology and a capacity of said main machine being expanded unlimitedly.

11. The process, as recited in claim 9, wherein said main machine and said terminal devices are connected by a connection selected from a group consisting of wired connection, wireless connection and combined wire/wireless connection.

12. The process, as recited in claim 9, wherein functions of each of said terminal devices are expandable according to a development of technology and each of said terminal devices is capable of processing professional classification and association due to needs.

13. The process, as recited in claim 9, wherein each of said terminal devices comprises an input/output device correspondingly.

14. The process, as recited in claim 9, wherein one or more additional main machines are connected with said terminal devices.

15. The process, as recited in claim 9, wherein each of said terminal devices is a receiver/sender.

16. The process, as recited in claim 9, wherein in the step (b), said single function inquiry is requested from said respective terminal devices via said display device.
